(19) United States
(12) Patent Application Publication
(10) Pub. No.: US 2006/0168484 A1
(43) Pub. Date: Jul. 27, 2006

(54) System and method for process degradation problematic tool identification

(76) Inventor: Eng Keong Ho, Singapore (SG)

Correspondence Address: HARNESS, DICKEY, & PIERCE, P.L.C, 7700 BONHOMME, STE 400, ST. LOUIS, MO, 63105, US

(21) Appl. No.: 10/538,396

(22) PCT Filed: Dec. 31, 2003
(86) PCT No.: PCT/SG03/00297

§ 371 Date: Jun. 9, 2005

(51) Int. Cl. G06F 11/00

(52) U.S. Cl. 714/47

(57) ABSTRACT

A method and system are provided for detecting suspect production tools, including testing produced products using a test sequence, said testing producing yield data, said yield data related to a production batch and a production process, said production process identified with a process tool. For each production process, a first data series R1 is calculated and stored, each element of said first series is the yield of a production batch divided by a baseline yield. For each production process, a second data series R2 is calculated and stored, each element of said second series is an m consecutive element moving average of R1. Also calculated and stored are a simple linear regression of R1, the standard deviations of data series R1 and R2. Lower trigger points for series R1 and R2 are calculated being 1-n standard deviations of R1 and R2 respectively for the last p or o data points. The R² of the simple linear regression of R1 is also calculated and stored. A set of decision rules are applied to the data series for each production process to produce a list of suspect processes, wherein each rule that is matched stores a match point against said production process. The rules include, a first rule matched when r consecutive elements of series R1 are lower than said lower trigger point of series R1, a second rule matched when s consecutive elements of series R2 are lower than said lower trigger point of series R2, and a third rule matched when R² is greater than a trigger point z. For each process tool the number of match points of said production processes identified with said tool is calculated, and a user is notified of said tools that have the most match points.

### TECHNICAL FIELD

This invention relates to a method and system for optimising system failure notification for products requiring quality to be within certain standards by enabling the identification of problematic tools.

### BACKGROUND

Rapid yield degradation detection in modern fabrication facilities is important. Identifying the cause cuts the losses suffered from process and equipment failure and helps improve profitability. The usual methods such as SPC control rules are not easily applied on non-normal distributions such as yield. In particular, if there is only a small yield loss, SPC rules are difficult to apply. This difficulty results in either the non-triggering or the slow triggering of the degradation, which may result in significant loss of profits.

Other problems in detecting degradation include the non-linear process manufacturing nature of wafer fabrication adding to the complexity of identifying degradation and the different volumes produced of different products.

### SUMMARY OF INVENTION

Accordingly what is needed overcomes the above disadvantages or at least provides the public or industry with a useful choice.

In a first aspect, the present invention may broadly be said to consist in a method of detecting suspect production tools, said method comprising:

testing produced products using a test sequence, said testing producing yield data, said yield data related to a production batch and a production process, said production process identified with a process tool;

calculating and storing for each production process a first data series R1, wherein each element of said first series is the yield of a production batch divided by a baseline yield;

calculating and storing for each production process a second data series R2, wherein each element of said second series is an m consecutive element moving average of R1;

calculating and storing a simple linear regression of R1;

calculating the standard deviations of data series R1 and R2;

calculating for each production process lower trigger points for series R1 1-n standard deviations of R1 for the last p data points;

calculating and storing for each production process lower trigger points for series R2 being 1-o standard deviations of R2 for the last o data points;

calculating and storing R2 of said simple linear regression of R1;

applying decision rules to data series for each production process to produce a list of suspect processes, wherein each rule that is matched stores a match point against said production process; wherein said rules include:
a first rule matched when r consecutive elements of series R1 are lower than said lower trigger point of series R1,
a second rule matched when s consecutive elements of series R2 are lower than said lower trigger point of series R2, and
a third rule matched when R² is greater than a trigger point z;

calculating for each process tool the number of match points of said production processes identified with said tool; and

notifying a user of said tools that have the most match points.

Preferably the values of m, n, o, p, r, s and z to be used are calculated using a confusion matrix and historic data, said data including data on the success and failure of detecting suspect production tools, said values to be used determined when the accuracy of detection and the capture rate are maximised.

In a second aspect, the present invention may broadly be said to consist in a method of detecting suspect production tools, said method comprising:

testing produced products using a test sequence, said testing producing yield data, said yield data related to a production batch and a production process, said production process identified with a process tool;

calculating and storing for each production process a first data series R1, wherein each element of said first series is the yield of a production batch divided by a baseline yield;

calculating the standard deviation of data series R1;

calculating for each production process lower trigger points for series R1 1-n standard deviations of R1 for the last p data points;

applying decision rules to data series for each production process to produce a list of suspect processes, wherein each rule that is matched stores a match point against said production process; wherein said rules include:
a first rule matched when r consecutive elements of series R1 are lower than said lower trigger point of series R1;

calculating for each process tool the number of match points of said production processes identified with said tool; and

notifying a user of said tools that have the most match points.

Preferably the values of m, n, o, p, r, s and z to be used are calculated using a confusion matrix and historic data, said data including data on the success and failure of detecting suspect production tools, said values to be used determined when the accuracy of detection and the capture rate are maximised.

In a third aspect, the present invention may broadly be said to consist in a method of detecting suspect production tools, said method comprising:

testing produced products using a test sequence, said testing producing yield data, said yield data related to a production batch and a production process, said production process identified with a process tool;

calculating and storing for each production process a first data series R1, wherein each element of said first series is the yield of a production batch divided by a baseline yield;

calculating and storing for each production process a second data series R2, wherein each element of said second series is an m consecutive element moving average of R1;

calculating the standard deviation of data series R2;

calculating and storing for each production process lower trigger points for series R2 being 1-o standard deviations of R2 for the last o data points;

applying decision rules to data series for each production process to produce a list of suspect processes, wherein each rule that is matched stores a match point against said production process; wherein said rules include:
a first rule matched when s consecutive elements of series R2 are lower than said lower trigger point of series R2;

calculating for each process tool the number of match points of said production processes identified with said tool; and

notifying a user of said tools that have the most match points.

Preferably the values of m, n, o, p, r, s and z to be used are calculated using a confusion matrix and historic data, said data including data on the success and failure of detecting suspect production tools, said values to be used determined when the accuracy of detection and the capture rate are maximised.

In a fourth aspect, the present invention may broadly be said to consist in a method of detecting suspect production tools, said method comprising:

testing produced products using a test sequence, said testing producing yield data, said yield data related to a production batch and a production process, said production process identified with a process tool;

calculating and storing for each production process a first data series R1, wherein each element of said first series is the yield of a production batch divided by a baseline yield;

calculating and storing a simple linear regression of R1;

calculating and storing R² of said simple linear regression of R1;

applying decision rules to data series for each production process to produce a list of suspect processes, wherein each rule that is matched stores a match point against said production process; wherein said rules include:
a first rule matched when R2 is greater than a trigger point z;

calculating for each process tool the number of match points of said production processes identified with said tool; and

notifying a user of said tools that have the most match points.

Preferably the values of m, n, o, p, r, s and z to be used are calculated using a confusion matrix and historic data, said data including data on the success and failure of detecting suspect production tools, said values to be used determined when the accuracy of detection and the capture rate are maximised.

In a fifth aspect, the present invention may broadly be said to consist in a method of detecting suspect production tools, said method comprising:

testing produced products using a test sequence, said testing producing yield data, said yield data related to a production batch and a production process, said production process identified with a process tool;

calculating and storing for each production process a first data series R1, wherein each element of said first series is the yield of a production batch divided by a baseline yield;

calculating and storing for each production process a second data series R2, wherein each element of said second series is an m consecutive element moving average of R1;

calculating the standard deviations of data series R1 and R2;

calculating for each production process lower trigger points for series R1 1-n standard deviations of R1 for the last p data points;

calculating and storing for each production process lower trigger points for series R2 being 1-o standard deviations of R2 for the last o data points;

applying decision rules to data series for each production process to produce a list of suspect processes, wherein each rule that is matched stores a match point against said production process; wherein said rules include:
a first rule matched when r consecutive elements of series R1 are lower than said lower trigger point of series R1, and
a second rule matched when s consecutive elements of series R2 are lower than said lower trigger point of series R2;

calculating for each process tool the number of match points of said production processes identified with said tool; and

notifying a user of said tools that have the most match points.

Preferably the values of m, n, o, p, r, s and z to be used are calculated using a confusion matrix and historic data, said data including data on the success and failure of detecting suspect production tools, said values to be used determined when the accuracy of detection and the capture rate are maximised.

In a sixth aspect, the present invention may broadly be said to consist in a method of detecting suspect production tools, said method comprising:

testing produced products using a test sequence, said testing producing yield data, said yield data related to a production batch and a production process, said production process identified with a process tool;

calculating and storing for each production process a first data series R1, wherein each element of said first series is the yield of a production batch divided by a baseline yield;

calculating and storing a simple linear regression of R1;

calculating the standard deviation of data series R1;

calculating for each production process lower trigger points for series R1 1-n standard deviations of R1 for the last p data points;

calculating and storing R² of said simple linear regression of R1;

applying decision rules to data series for each production process to produce a list of suspect processes, wherein each rule that is matched stores a match point against said production process; wherein said rules include:
a first rule matched when r consecutive elements of series R1 are lower than said lower trigger point of series R1, and
a second rule matched when R² is greater than a trigger point z;

calculating for each process tool the number of match points of said production processes identified with said tool; and

notifying a user of said tools that have the most match points.

Preferably the values of m, n, o, p, r, s and z to be used are calculated using a confusion matrix and historic data, said data including data on the success and failure of detecting suspect production tools, said values to be used determined when the accuracy of detection and the capture rate are maximised.

In a seventh aspect, the present invention may broadly be said to consist in a method of detecting suspect production tools, said method comprising:

testing produced products using a test sequence, said testing producing yield data, said yield data related to a production batch and a production process, said production process identified with a process tool;

calculating and storing for each production process a first data series R1, wherein each element of said first series is the yield of a production batch divided by a baseline yield;

calculating and storing for each production process a second data series R2, wherein each element of said second series is an m consecutive element moving average of R1;

calculating and storing a simple linear regression of R1;

calculating the standard deviation of data series R2;

calculating and storing for each production process lower trigger points for series R2 being 1-o standard deviations of R2 for the last o data points;

calculating and storing R2 of said simple linear regression of R1;

applying decision rules to data series for each production process to produce a list of suspect processes, wherein each rule that is matched stores a match point against said production process; wherein said rules include:
a first rule matched when s consecutive elements of series R2 are lower than said lower trigger point of series R2, and
a second rule matched when R² is greater than a trigger point z;

calculating for each process tool the number of match points of said production processes identified with said tool; and

notifying a user of said tools that have the most match points.

Preferably the values of m, n, o, p, r, s and z to be used are calculated using a confusion matrix and historic data, said data including data on the success and failure of detecting suspect production tools, said values to be used determined when the accuracy of detection and the capture rate are maximised.

In an eighth aspect, the present invention may broadly be said to consist in a system implementing any of the above methods.

In a ninth aspect, the present invention may broadly be said to consist in software for effecting any of the above methods.

### BRIEF DESCRIPTION OF THE DRAWINGS

FIG. 1 is a block diagram of the system according to the invention illustrating the hardware components and the interconnection between the components,

FIG. 2 is a flow diagram illustrating the process of the present invention,

FIG. 3 is a diagram illustrating a yield index,

FIG. 4 is a diagram illustrating a three lot moving yield index,

FIG. 5 is a diagram illustrating a yield index showing lower and upper trigger points,

FIG. 6 is a diagram illustrating the fitting of a linear regression curve to a yield index,

FIG. 7 is an example of the confusion matrix of the present invention,

FIG. 8 is a diagram showing raw production yield data, and

FIG. 9 is a diagram showing the method of the present invention applied to the data shown in FIG. 8.

### DETAILED DESCRIPTION OF THE EXEMPLARY EMBODIMENTS

The present invention consists of a method of identifying failure in a manufacturing system and in particular to identify processing tools that are causing problems in the manufacturing process.

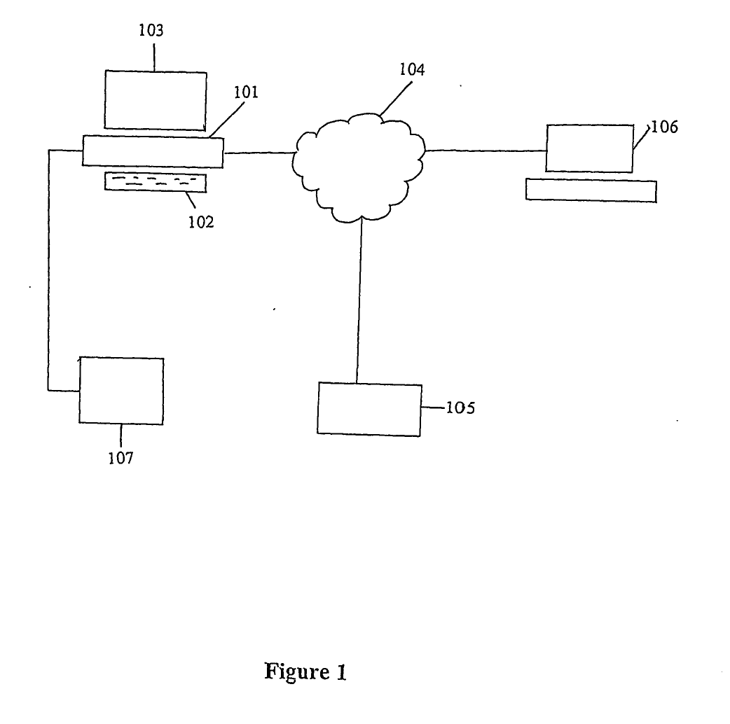

Referring to FIG. 1, a data processing system 103 for practicing the present invention is shown. A computing device 101 including at least one CPU, system memory, a data storage device, means to input data 102 such as a keyboard and a display device is shown. The computing device will preferable be connected to a network 104 through a network interface or adaptor. The network 104 preferably includes connections to testing systems 105 in a fabrication plant and other computer systems 106. The system can also include devices for informing users such as printers 107.

While in the preferred form of the invention the testing systems are directly connected to the computer system, the data required by the present invention can be entered either manually or via other means, such as being stored on portable storage media.

The system of the present invention receives the yield of all lots or batches processed through a fabrication plant. In the preferred embodiment, the system would receive the yield of all processing steps required in fabrication. The processing steps are identified with production tools.

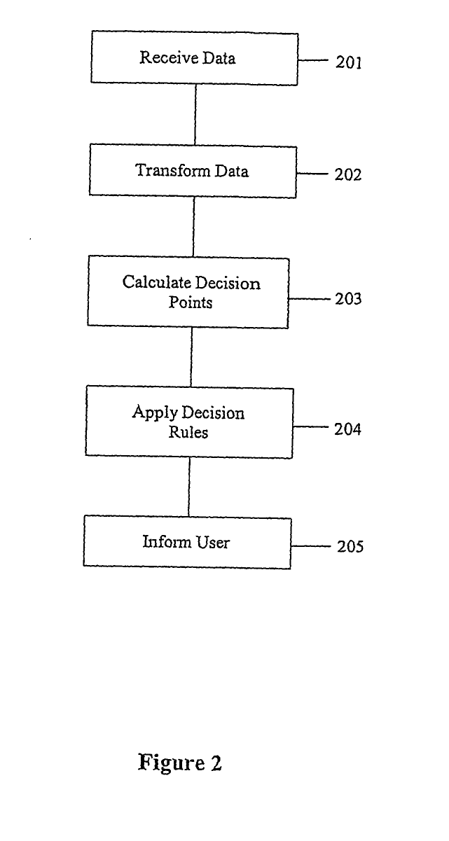

Referring to FIG. 2, the method consists of obtaining the necessary data 201 and transforming the data 202. Based on the obtained data, decision points 203 are calculated, and the data is sorted based on the processing time at each step of the manufacturing process. Having sorted the data, a set of decision rules are applied 204 to identify abnormalities in processing steps. The abnormalities are then stored and the system identifies the steps in the manufacturing process and from the steps the tools that are potentially suspect and informs the user 205. In the preferred embodiment, the system informs the user via email, however the system could print reports or notify the system user by other suitable means.

The data obtained preferably includes information on the equipment identification, the processing step, the processing time and the yield. The yield is preferable the number of products produced that meet the required standard divided by the number of products produced in a particular batch. From the raw data, a normalised dataset is created. Normalising yield across products has the advantage that all products can be used in the triggering instead of only one product.

The transformation process consists of calculating a normalised yield index consisting of the yield of a given batch divided by a baseline yield. This dataset is stored as R1. The baseline yield is the median yield of all batches of the step over a long period. In the preferred embodiment, the period is preferably 30 days.

Additionally the normalised yield index is recalculated as a three lot moving average of the dataset R1. This is stored as dataset R2. A further dataset R3 is calculated by fitting a linear regression model using the least square method to dataset R1 and extracting R2. R is a measure of the goodness of fit and lies between 0 and 1.

The system using datasets R1 and R2 then calculates upper and lower trigger points. Sigma of the population is calculated being a standard deviation of the data sat and the upper trigger point is calculated as 1+2sigma. The lower trigger point is calculated as 1−2sigma. For R1 and R2 if the yield index is less than the lower trigger point the batch is identified as a decreasing point. If the yield index is the upper trigger point, the batch is an increasing point. In the preferred embodiment, n is 2.

To identify whether a batch is a trigger point, the system then applies a set of rules. Three rules have been identified as appropriate based on testing of the method. If the number of consecutive decreasing points for series R1 exceeds a certain number, then the first rule is triggered. If the number of consecutive decreasing points for series R2 exceeds a certain number, then the second rule is triggered. The third rule is triggered if the R value is greater than a certain value.

In the most preferred embodiment, the first rule is triggered if more than four consecutive points in series R1 are decreasing, and the second rule is triggered if more than three consecutive points in series R2 are decreasing. In relation to R3, if R² is greater than 0.1 (depending on process) then the third rule is triggered.

The trigger rules will differ between processes. They are, however, the same for all process steps, but different for each technology. The trigger rules can be calculated ahead of time. The system will then mark the processes that trigger rules and will sort the processes by the number of trigger rules and will identify to users the suspect processes.

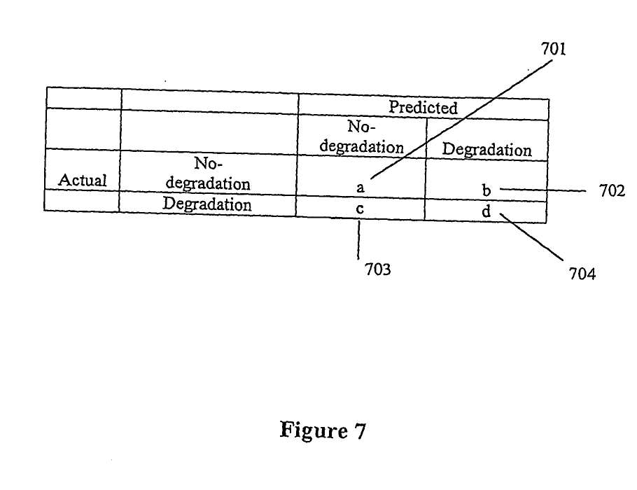

The trigger rules are calculated using a confusion matrix. Referring to FIG. 7, a confusion matrix as it applies to the present invention is shown. The cell marked “a” 701 represents the number of times that the method has predicted that there is no degradation correctly. The cell marked “b” 702 represents the number of times that the method has predicted degradation incorrectly. The cell marked “c” 703 represents the number of times that the method has not predicted degradation when there has been degradation. The cell marked “d” 704 is the number of times the system has correctly predicted degradation.

In the case of this method, the accuracy of the number of times that the method does not trigger is not important. Therefore, the accuracy of the method is defined as d/(d+b) and the capture rate being the number of times degradation is correctly identified is defined as d/(c+d).

In the preferred embodiment, data on identified degradation is obtained and stored. This includes data on correctly and incorrectly predicted degradation and data on degradation not predicted by the method. The system recalculates the trigger points until the accuracy and the trigger rate of the proposed trigger points are above 90%.

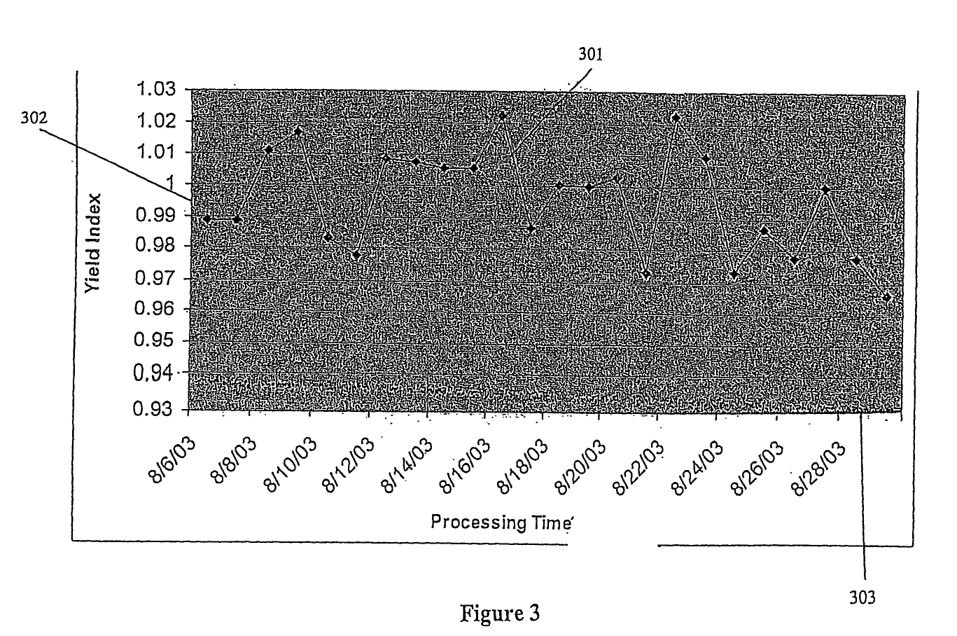

Referring to FIGS. 3 to 6, the present invention will be illustrated with reference to an example. In FIG. 3, the normalised data 301 is graphed. The Y axis 302 is the yield index, and the capitalize axis 303 is time. Looking at line 301 it is unclear what the trend is.

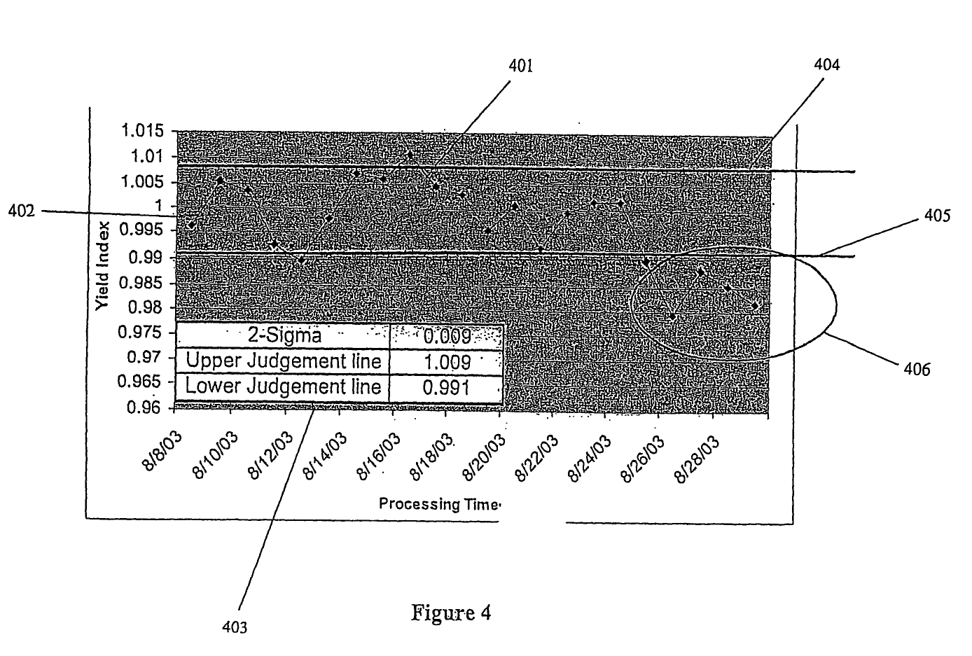

In FIG. 4, a three lot moving average 401 has been graphed. Again, the Y axis 402 is the yield index, and the X axis 403 is time. Two-sigma of the series has been calculated at 0.009, and, therefore the upper limit calculated at 1.009 and the lower limit at 0.991. The upper limit is shown by line 404, and the lower limit is show in the graph as line 405. Using criteria of more than four consecutive decreasing points shown by circle 406, the process or step triggers the first rule.

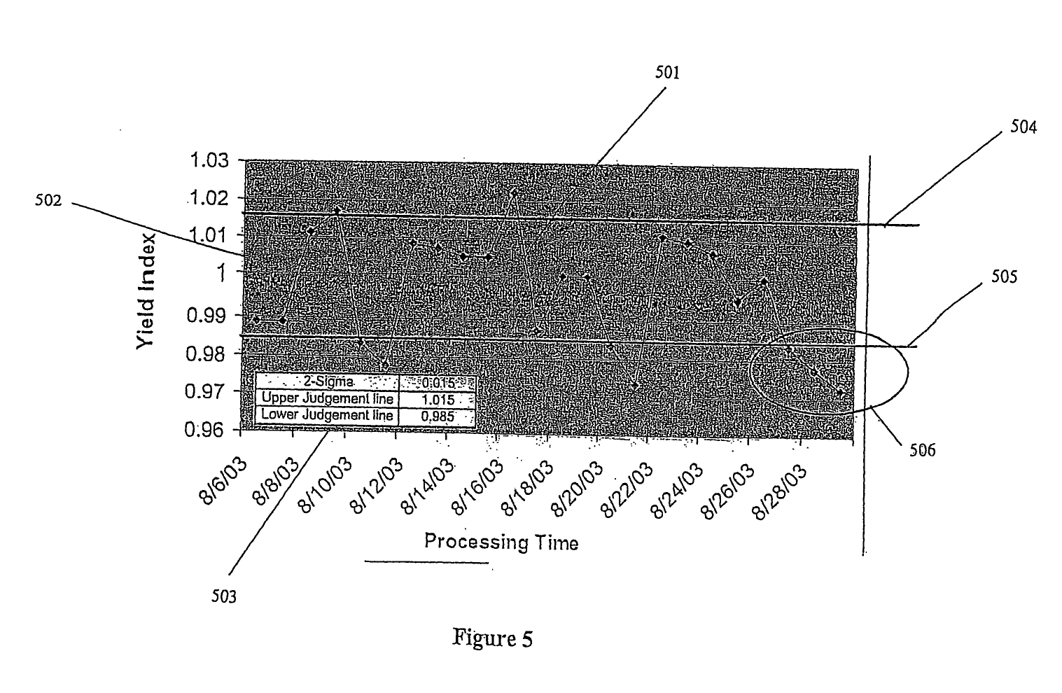

Referring to FIG. 5, the normalised yield index 501 has been graphed, and two-sigma for the series been calculated at 0.015. Therefore, the upper and lower trigger points are 1.015 and 0.985, respectively. The upper and lower trigger points are show on the graphs as lines 504 and 505. Again, the Y axis 502 is the yield index, and the X axis 503 is time. The second control rule criteria of number of consecutive decreasing points being more than three will be triggered.

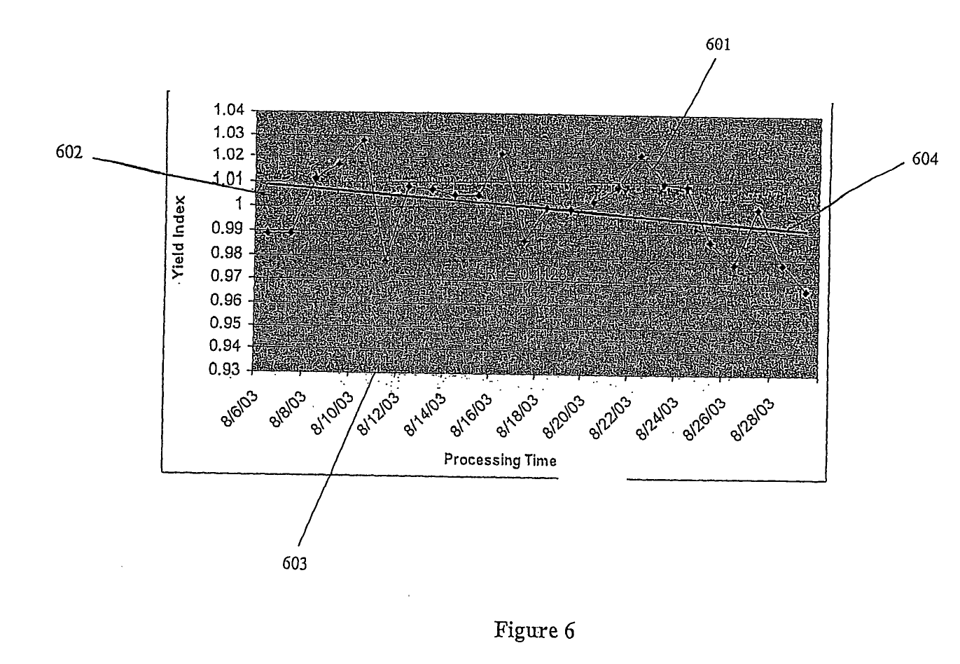

Referring to FIG. 6, the yield index has again been graphed 601 and a least square regression model fitted 604. The Y axis 602 is the yield index, and the X axis 603 is time. R2 for the model has been calculated at 0.1128, and the trigger R2 set at greater than 0.1.

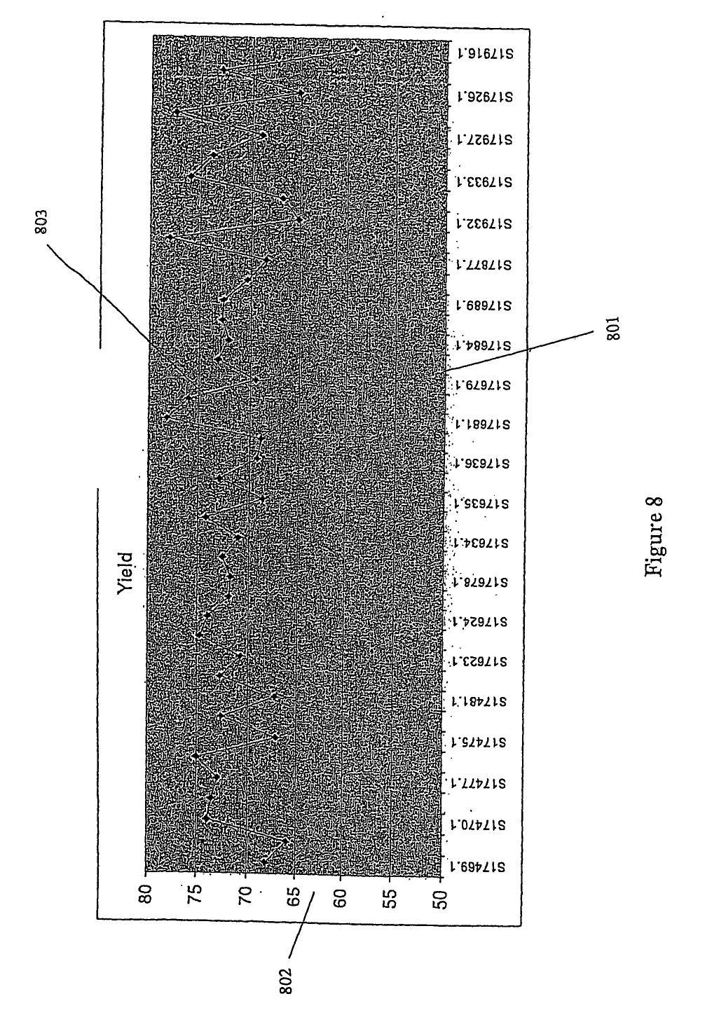

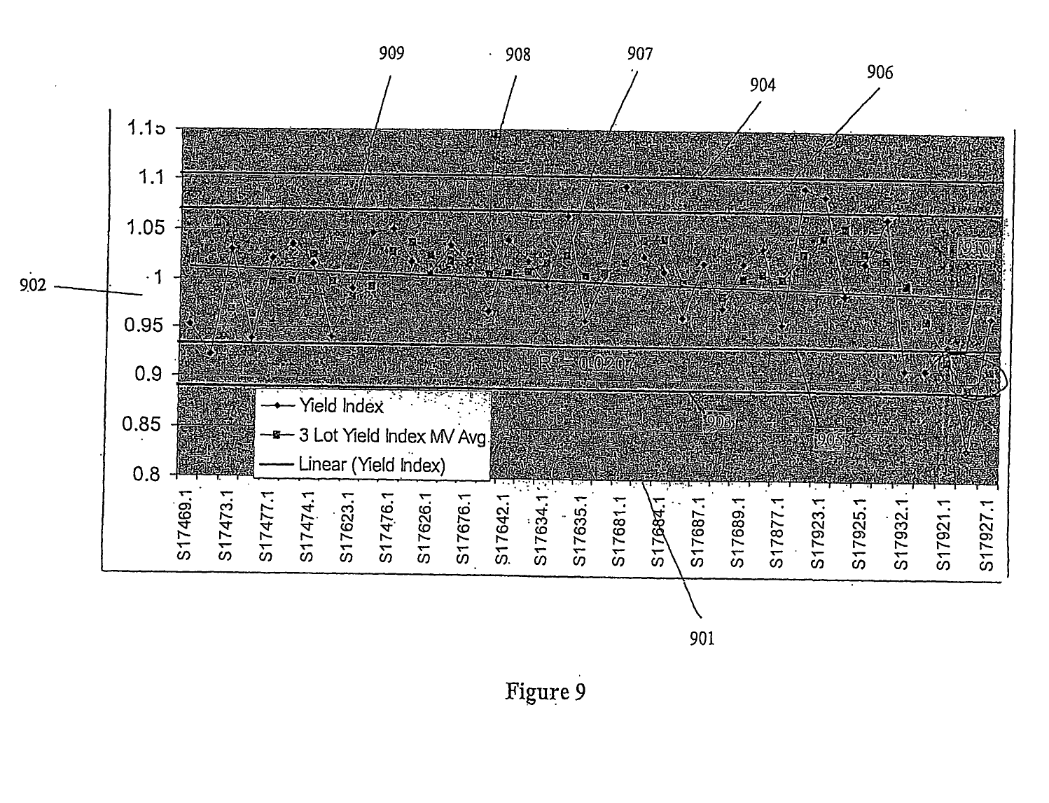

Referring to FIGS. 8 and 9, actual data has been captured, and the method of the present invention applied. FIG. 8 shows the raw data and the difficulty in predicting degradation using the raw data. The X axis 801 represents the process batches, and the Y axis represents the yield. As the graph 803 shows, the yield moves up and down, and no trend (and therefore no degradation) can be predicted. FIG. 9 shows the data with the method of the present invention applied. Again, the X axis 901 represents the process batches, but the Y axis 902 represents the normalised yield. R1 901 is a graph of the normalised yield, and the upper trigger point for the normalised yield has been calculated and is shown by line 904, and lower trigger point calculated and shown as line 903.

R2 being a tree point moving average of R1 has been calculated and is graphed 908, the upper trigger point has been calculated and shown as line 906, and the lower trigger point calculated and shown as line 905. A linear regression has been applied to R1, and the result graphed as line 909. The R2 value for the linear regression has been calculated as 0.0207. The rule that three or more points of R2 below the lower trigger point of R2 has been triggered. The three points are shown enclosed by a circle 910. The triggering of the rule has correctly identified degradation in a process.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

1-17. (canceled)

18. A method of detecting suspect production tools, said method comprising:
testing produced products using a test sequence, said testing producing yield data, said yield data related to a production batch and a production process, said production process identified with a process tool;
calculating and storing for each production process a first data series R1, wherein each element of said first series is the yield of a production batch divided by a baseline yield;
calculating and storing for each production process a second data series R2, wherein each element of said second series is an m consecutive element moving average of R1;
calculating and storing a simple linear regression of R1;
calculating the standard deviations of data series R1 and R2;
calculating for each production process lower trigger points for series R1 1-n standard deviations of R1 for the last p data points;
calculating and storing for each production process lower trigger points for series R2 being 1-o standard deviations of R2 for the last o data points;
calculating and storing R2 of said simple linear regression of R1;
applying decision rules to data series for each production process to produce a list of suspect processes, wherein each rule that is matched stores a match point against said production process; wherein said rules include:
a first rule matched when r consecutive elements of series R1 are lower than said lower trigger point of series R1,
a second rule matched when s consecutive elements of series R2 are lower than said lower trigger point of series R2, and
a third rule matched when R² is greater than a trigger point z;
calculating for each process tool the number of match points of said production processes identified with said tool; and notifying a user of said tools that have the most match points.

19. A method of detecting suspect production tools as claimed in claim 18 wherein the values of m, n, o, p, r, s and z to be used are calculated using a confusion matrix and historic data, said data including data on the success and failure of detecting suspect production tools, said values to be used determined when the accuracy of detection and the capture rate are maximized.

20. A system implementing the method of claim 18.

21. Software for effecting the method of claim 18.

22. A method of detecting suspect production tools, said method comprising:
testing produced products using a test sequence, said testing producing yield data, said yield data related to a production batch and a production process, said production process identified with a process tool;
calculating and storing for each production process a first data series R1, wherein each element of said first series is the yield of a production batch divided by a baseline yield;
calculating the standard deviation of data series R1;
calculating for each production process lower trigger points for series R1 1-n standard deviations of R1 for the last p data points;
applying decision rules to data series for each production process to produce a list of suspect processes, wherein each rule that is matched stores a match point against said production process; wherein said rules include:
a first rule matched when r consecutive elements of series R1 are lower than said lower trigger point of series R1;
calculating for each process tool the number of match points of said production processes identified with said tool; and
notifying a user of said tools that have the most match points.

23. A method of detecting suspect production tools as claimed in claim 22 wherein the values of m, n, o, p, r, s and z to be used are calculated using a confusion matrix and historic data, said data including data on the success and failure of detecting suspect production tools, said values to be used determined when the accuracy of detection and the capture rate are maximized.

24. A system implementing the method of claim 22.

25. Software for effecting the method of claim 22.

26. A method of detecting suspect production tools, said method comprising:
testing produced products using a test sequence, said testing producing yield data, said yield data related to a production batch and a production process, said production process identified with a process tool;
calculating and storing for each production process a first data series R1, wherein each element of said first series is the yield of a production batch divided by a baseline yield;
calculating and storing for each production process a second data series R2, wherein each element of said second series is an m consecutive element moving average of R1;
calculating the standard deviation of data series R2;
calculating and storing for each production process lower trigger points for series R2 being 1-o standard deviations of R2 for the last o data points;
applying decision rules to data series for each production process to produce a list of suspect processes, wherein each rule that is matched stores a match point against said production process; wherein said rules include:
a first rule matched when s consecutive elements of series R2 are lower than said lower trigger point of series R2;
calculating for each process tool the number of match points of said production processes identified with said tool; and
notifying a user of said tools that have the most match points.

27. A method of detecting suspect production tools as claimed in claim 26 wherein the values of m, n, o, p, r, s and z to be used are calculated using a confusion matrix and historic data, said data including data on the success and failure of detecting suspect production tools, said values to be used determined when the accuracy of detection and the capture rate are maximized.

28. A system implementing the method of claim 26.

29. Software for effecting the method of claim 26.

30. A method of detecting suspect production tools, said method comprising:
testing produced products using a test sequence, said testing producing yield data, said yield data related to a production batch and a production process, said production process identified with a process tool;
calculating and storing for each production process a first data series R1, wherein each element of said first series is the yield of a production batch divided by a baseline yield;
calculating and storing a simple linear regression of R1;
calculating and storing R² of said simple linear regression of R1;
applying decision rules to data series for each production process to produce a list of suspect processes, wherein each rule that is matched stores a match point against said production process; wherein said rules include:
a first rule matched when R² is greater than a trigger point z;
calculating for each process tool the number of match points of said production processes identified with said tool; and
notifying a user of said tools that have the most match points.

31. A method of detecting suspect production tools as claimed in claim 30 wherein the values of m, n, o, p, r, s and z to be used are calculated using a confusion matrix and historic data, said data including data on the success and failure of detecting suspect production tools, said values to be used determined when the accuracy of detection and the capture rate are maximized.

32. A system implementing the method of claim 30.

33. Software for effecting the method of claim 30.

34. A method of detecting suspect production tools, said method comprising:
testing produced products using a test sequence, said testing producing yield data, said yield data related to a production batch and a production process, said production process identified with a process tool;
calculating and storing for each production process a first data series R1, wherein each element of said first series is the yield of a production batch divided by a baseline yield;
calculating and storing for each production process a second data series R2, wherein each element of said second series is an m consecutive element moving average of R1;
calculating the standard deviations of data series R1 and R2;
calculating for each production process lower trigger points for series R1 1-n standard deviations of R1 for the last p data points;
calculating and storing for each production process lower trigger points for series R2 being 1-o standard deviations of R2 for the last o data points;
applying decision rules to data series for each production process to produce a list of suspect processes, wherein each rule that is matched stores a match point against said production process; wherein said rules include:
a first rule matched when r consecutive elements of series R1 are lower than said lower trigger point of series R1, and
a second rule matched when s consecutive elements of series R2 are lower than said lower trigger point of series R2;
calculating for each process tool the number of match points of said production processes identified with said tool; and
notifying a user of said tools that have the most match points.

35. A method of detecting suspect production tools as claimed in claim 34 wherein the values of m, n, o, p, r, s and z to be used are calculated using a confusion matrix and historic data, said data including data on the success and failure of detecting suspect production tools, said values to be used determined when the accuracy of detection and the capture rate are maximized.

36. A system implementing the method of claim 34.

37. Software for effecting the method of claim 34.

38. A method of detecting suspect production tools, said method comprising:
testing produced products using a test sequence, said testing producing yield data, said yield data related to a production batch and a production process, said production process identified with a process tool;
calculating and storing for each production process a first data series R1, wherein each element of said first series is the yield of a production batch divided by a baseline yield;
calculating and storing a simple linear regression of R1;
calculating the standard deviation of data series R1;
calculating for each production process lower trigger points for series R1 1-n standard deviations of R1 for the last p data points;
calculating and storing R of said simple linear regression of R1;
applying decision rules to data series for each production process to produce a list of suspect processes, wherein each rule that is matched stores a match point against said production process; wherein said rules include:
a first rule matched when r consecutive elements of series R1 are lower than said lower trigger point of series R1, and
a second rule matched when R2 is greater than a trigger point z;
calculating for each process tool the number of match points of said production processes identified with said tool; and
notifying a user of said tools that have the most match points.

39. A method of detecting suspect production tools as claimed in claim 38 wherein the values of m, n, o, p, r, s and z to be used are calculated using a confusion matrix and historic data, said data including data on the success and failure of detecting suspect production tools, said values to be used determined when the accuracy of detection and the capture rate are maximized.

40. A system implementing the method of claim 38.

41. Software for effecting the method of claim 38.

42. A method of detecting suspect production tools, said method comprising:
testing produced products using a test sequence, said testing producing yield data, said yield data related to a production batch and a production process, said production process identified with a process tool;
calculating and storing for each production process a first data series R1, wherein each element of said first series is the yield of a production batch divided by a baseline yield;
calculating and storing for each production process a second data series R2, wherein each element of said second series is an m consecutive element moving average of R1;
calculating and storing a simple linear regression of R1;
calculating the standard deviation of data series R2;
calculating and storing for each production process lower trigger points for series R2 being 1-o standard deviations of R2 for the last o data points;
calculating and storing R of said simple linear regression of R1;
applying decision rules to data series for each production process to produce a list of suspect processes, wherein each rule that is matched stores a match point against said production process; wherein said rules include:
a first rule matched when s consecutive elements of series R2 are lower than said lower trigger point of series R2, and
a second rule matched when R² is greater than a trigger point z;
calculating for each process tool the number of match points of said production processes identified with said tool; and
notifying a user of said tools that have the most match points.

43. A method of detecting suspect production tools as claimed in claim 42 wherein the values of m, n, o, p, r, s and z to be used are calculated using a confusion matrix and historic data, said data including data on the success and failure of detecting suspect production tools, said values to be used determined when the accuracy of detection and the capture rate are maximized.

44. A system implementing the method of claim 42.

45. Software for effecting the method of claim 42.
